(19) United States
(12) Patent Application Publication
(10) Pub. No.: US 2025/0242646 A1
(43) Pub. Date: Jul. 31, 2025

(54) VEHICLE WITH FRONT SUSPENSION ASSEMBLIES

(71) Applicant: BOMBARDIER RECREATIONAL PRODUCTS INC., Valcourt (CA)

(72) Inventor: Daniel LECLERC, Saint-Denis-de-Brompton (CA)

(21) Appl. No.: 19/027,318

(22) Filed: Jan. 17, 2025

Related U.S. Application Data
(60) Provisional application No. 63/627,245, filed on Jan. 31, 2024.

(51) Int. Cl. B60G 3/20; B60G 7/00; B60G 13/00; B62D 7/18

(52) U.S. Cl. CPC B60G 3/20; B60G 7/005; B60G 13/003; B60G 13/005; B62D 7/18; B60G 2200/144

(57) ABSTRACT

A vehicle includes a frame, front left and right suspension assemblies, front left and right wheels operatively connected to, respectively, the front left and right suspension assemblies, at least one rear wheel and a motor. Each of the front left and right suspensions assemblies includes a knuckle, a lower arm, first and second upper links, and a shock absorber assembly. The knuckle includes a wheel hub, a first portion including a lower ball joint, and a second portion including first and second upper ball joints. The lower arm having laterally outward end portion pivotally connected to the lower ball joint of the knuckle and two laterally inward end portions pivotally connected to the frame. The first and second upper links having a laterally outward end portions connected to, respectively, first and second upper ball joints, and laterally inward end portions connected to the frame.

### CROSS-REFERENCE TO RELATED APPLICATIONS

The present application claims priority to U.S. Provisional Patent Application No. 63/627,245, filed Jan. 31, 2024 entitled “Vehicle With Front Suspension Assemblies”, which is incorporated by reference herein in its entirety.

### FIELD OF TECHNOLOGY

The present technology relates to front suspension assemblies for vehicles.

### BACKGROUND

Suspension systems in vehicles enable their corresponding ground-engaging members (e.g., wheels) to move up and down with respect to their vehicle frame. By their geometry, suspension systems define, for each ground-engaging member of their respective vehicle, a steering axis (sometimes referred-to as “kingpin axis”) about which the ground-engaging member rotates during steering. Depending on respective locations and orientations of the steering axes of the ground-engaging members, existing suspension systems may cause the vehicle to move upwards during steering, which may induce strain on the frame at points where the suspension assemblies connect.

Also, for vehicles designed to be used in off-road conditions, it is desirable to have suspension assemblies with relatively large travel capabilities to handle bumpy terrains, obstacles, etc. However, as the wheels move up and down with the suspension assemblies, further strain can be induced on the frame at points where the suspension assemblies connect. If the stress is substantial and concentrated over a small portion of the frame, the frame could be negatively affected. The total amount of travel available in front suspension assemblies can further be limited by the arrangement of drive shafts, shock absorbers and/or steering assemblies.

Additionally, while it may be advantageous to equip the vehicle with wheels having large diameters, existing suspension systems may limit a maximum size of the wheels, for example due to components of the suspension systems extending over the wheels.

Thus, there is a desire for a suspension assembly suitable for off-road operating conditions while not limiting a size of the wheels.

### SUMMARY

It is an object of the present technology to ameliorate at least some of the inconveniences present in the prior art.

According to one aspect of the present technology, there is provided a vehicle including a frame, a front left suspension assembly connected to the frame, a front left wheel operatively connected to the front left suspension assembly, a front right suspension assembly connected to the frame, a front right wheel operatively connected to the front right suspension assembly, at least one rear wheel operatively connected to the frame, and a motor. The motor is operatively connected to at least one of the front left wheel and the front right wheel, and the at least one rear wheel. Each of the front left suspension and the front right suspension assembly includes a knuckle, a lower arm, a first upper link, a second upper link and a shock absorber. The knuckle is pivotally connected to a corresponding one of the front left wheel and the front right wheel. The knuckle includes a wheel hub, a first portion and a second portion. The wheel hub is operatively connected to the corresponding one of the front left wheel and the front right wheel. The first portion is connected to the wheel hub, and includes a lower ball joint. The second portion is connected to and extends generally upward from the first portion, and includes a first upper ball joint and a second upper ball joint. With the front left wheel and the front right wheel being steered to guide the vehicle straight ahead, the first upper ball joint and the second upper ball joint are longitudinally spaced from one another. The lower arm has a laterally outward end portion pivotally connected to the lower ball joint of the knuckle and two laterally inward end portions pivotally connected to the frame. The first upper link has a laterally outward end portion pivotally connected to the first upper ball joint, and a laterally inward end portion pivotally connected to the frame, The second upper link has a laterally outward end portion pivotally connected to the second upper ball joint, and a laterally inward end portion pivotally connected to the frame. The laterally inward end portion of the second upper link is longitudinally spaced from the laterally inward end portion of the first upper link. A shock absorber assembly has a lower end portion pivotally connected to the lower arm and an upper end portion pivotally connected to the frame.

In some embodiments, for each of the front left suspension and the front right suspension assembly, the laterally outward end portion of the first upper link is disposed laterally between the laterally inward end portion of the first upper link and the corresponding one of the front left wheel and the front right wheel; and the laterally outward end portion of the second upper link is disposed laterally between the laterally inward end portion of the second upper link and the corresponding one of the front left wheel and the front right wheel.

In some embodiments, for each of the front left suspension and the front right suspension assembly a virtual pivot point is determined at an intersection of a first line extending through the laterally inward end portion of the first upper link and through the first upper ball joint, and a second line extending through the laterally inward end portion of the second upper link and through the second upper ball joint. The corresponding one of the front left wheel and the front right wheel is steerable about a steering axis defined by the virtual pivot point and the lower ball joint.

In some embodiments, for each of the front left suspension assembly and the front right suspension assembly, with the front left wheel and the front right wheel being steered to guide the vehicle straight ahead, the virtual pivot point is disposed laterally between an inward side of the corresponding one of the front left wheel and the front right wheel and an outward side of the corresponding one of the front left wheel and the front right wheel.

In some embodiments, for each of the front left suspension assembly and the front right suspension assembly, the virtual pivot point is located higher than, in a heigthwise direction of the vehicle, a top of the corresponding one of the front left wheel and the front right wheel.

In some embodiments, for each of the front left suspension assembly and the front right suspension assembly, the virtual pivot point is located lower than, in a heigthwise direction of the vehicle, a top of the corresponding one of the front left wheel and the front right wheel.

In some embodiments, for each of the front left suspension assembly and the front right suspension assembly, in response to a movement of the corresponding one of the front left wheel and the front right wheel, the virtual pivot point is moveable in a virtual zone, and the virtual zone is located higher than, in a heigthwise direction of the vehicle, a wheel rotation axis of the corresponding one of the front left wheel and the front right wheel.

In some embodiments, for each of the front left suspension assembly and the front right suspension assembly, at least a majority of the virtual zone is disposed between an inward side of the corresponding one of the front left wheel and the front right wheel, and an outward side of the corresponding one of the front left wheel and the front right wheel.

In some embodiments, for each of the front left suspension assembly and the front right suspension assembly, with the front left wheel and the front right wheel being steered to guide the vehicle straight ahead and with the vehicle resting on a flat level surface, an angle between the steering axis and a heightwise direction of the vehicle is greater than 0 degrees and less than or equal to 6 degrees.

In some embodiments, for each of the front left suspension assembly and the front right suspension assembly, with the front left wheel and the front right wheel being steered to guide the vehicle straight ahead and with the vehicle resting on a flat level surface, the angle between the steering axis and the heightwise direction of the vehicle is greater than 2 degrees and less than or equal to 4 degrees.

In some embodiments, for each of the front left suspension assembly and the front right suspension assembly, with the front left wheel and the front right wheel being steered to guide the vehicle straight ahead and with the vehicle resting on a flat level surface, a first lateral distance is defined from the laterally inward end portion of the first upper link to the laterally outward end portion of the first upper link, a second lateral distance is defined from the laterally inward end portion of the first upper link to the virtual pivot point, and a ratio of the first lateral distance over the second lateral distance is between 0.7 and 0.85. Additionally, a third lateral distance is defined from the laterally inward end portion of the second upper link to the laterally outward end portion of the second upper link, a fourth lateral distance is defined from the laterally inward end portion of the second upper link to the virtual pivot point, and a ratio of the third lateral distance over the fourth lateral distance is between 0.7 and 0.85.

In some embodiments, for each of the front left suspension assembly and the front right suspension assembly the ratio of the first lateral distance over the second lateral distance is between 0.75 and 0.8, and the ratio of the third lateral distance over the fourth lateral distance is between 0.75 and 0.8.

In some embodiments, for each of the front left suspension assembly and the front right suspension assembly, a center-to-center spacing between the first upper ball joint and the second upper ball joint is between 0.5 inches and 4 inches.

In some embodiments, for each of the front left suspension assembly and the front right suspension assembly, a corresponding one of the front left suspension assembly and the front right suspension assembly is completely outside of a zone defined above the corresponding one of the front left wheel and the front right wheel in a heightwise direction of the vehicle.

In some embodiments, the front suspension is configured to accommodate a tire having an outer diameter of at least 33 inches.

In some embodiments, for each of the front left suspension assembly and the front right suspension assembly, the shock absorber assembly is disposed longitudinally between the first upper link and the second upper link.

In some embodiments, the vehicle further includes a driver seat connected to the frame, a steering wheel disposed forward of the driver seat, and a steering assembly operatively connected to the steering wheel. Each of the front left suspension assembly and the front right suspension assembly further includes a steering ball joint connected to the knuckle, and a steering rod having a laterally inward end portion operatively connected to the steering assembly, and a laterally outward end portion connected to the steering ball joint.

In some embodiments, for each of the front left suspension assembly and the front right suspension assembly, the steering rod is disposed rearward of the shock absorber assembly.

In some embodiments, the vehicle further includes a rear left suspension assembly connected to the frame and a rear right suspension assembly connected to the frame, and the at least one rear wheel includes a rear left wheel operatively connected to the rear left suspension assembly, and a rear right wheel operatively connected to the rear right suspension assembly.

In some embodiments, the motor includes an engine.

According to another aspect of the present technology, there is provided: a vehicle comprising a frame, a front left suspension assembly connected to the frame, a front left wheel operatively connected to the front left suspension assembly, a front right suspension assembly connected to the frame, a front right wheel operatively connected to the front right suspension assembly, at least one rear wheel operatively connected to the frame, and a motor operatively connected to at least one of the front left wheel and the front right wheel, and the at least one rear wheel. Each one of the front left suspension and the front right suspension includes a knuckle operatively connected to a corresponding one of the front left wheel and the front right wheel, at least one lower arm connected between the knuckle and the frame, and at least one upper arm connected between the knuckle and the frame. For each one of the front left suspension and the front right suspension with the front left wheel and the front right wheel being steered to guide the vehicle straight ahead, a corresponding one of the front left wheel and the front right wheel is steerable about a steering axis defined by a virtual pivot point and a connection between the knuckle and the at least one lower arm, the virtual pivot point being located laterally between an inner side of the corresponding one of the front left wheel and the front right wheel and an outer side of the corresponding one of the front left wheel and the front right wheel. Additionally, for each one of the front left suspension and the front right suspension a corresponding one of the front left suspension assembly and the front right suspension assembly being completely outside of a zone defined above the corresponding one of the front left wheel and the front right wheel in a heightwise direction of the vehicle.

For purposes of this application, terms related to spatial orientation such as forwardly, rearward, upwardly, downwardly, left, and right, are as they would normally be understood by a driver of the vehicle sitting thereon in a normal riding position. Terms related to spatial orientation when describing or referring to components or sub-assemblies of the vehicle, separately from the vehicle should be understood as they would be understood when these components or sub-assemblies are mounted to the vehicle, unless specified otherwise in this application.

For purposes of this application, unless specified otherwise, the terms “above” and “below” are for describing a vertical positioning of a first element with respect to a second element, where the first element is generally contained within a plane of the second element, whereas the terms “higher than” and “lower than” are for describing a vertical positioning of the first element with respect to the second element, but where the first element does not generally have to be contained within a plane of the second element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of an off-road vehicle taken from a front, top, left side;

FIG. 2 is a left side elevation view of the vehicle of FIG. 1;

FIG. 3 is a top plan view of some vehicle components of the vehicle of FIG. 1, including part of a frame, a steering assembly, front suspension assemblies and front wheels;

FIG. 4 is a perspective view taken from a rear, top, right side of the frame, the front suspension assemblies and the front wheels of FIG. 3;

FIG. 5 is a perspective view taken from a rear, top, right side of the front suspension assemblies and the front wheels of FIG. 4;

FIG. 6 is a front elevation view of the front suspension assemblies and the front wheels of FIG. 5;

FIG. 7 is a top plan view of the front suspension assemblies and the front wheels of FIG. 5;

FIG. 8 is a perspective view taken from a rear, top, left side of a front left suspension assembly of the front suspension assemblies of FIG. 5;

FIG. 9 is a perspective view taken from a rear, top, right side of the front left suspension assembly of FIG. 8;

FIG. 10 is a rear elevation view of the front left suspension assembly of FIG. 8;

FIG. 11 is a top plan view of a front suspension assembly and a front wheel according to an alternative embodiment;

FIG. 12 is a top plan view of a front suspension assembly and a front wheel according to an alternative embodiment;

FIG. 13 is a top plan view of a front suspension assembly and a front wheel according to an alternative embodiment; and

FIG. 14 is a front elevation of a front suspension assembly and a front wheel according to an alternative embodiment.

It should be noted that the Figures may not be drawn to scale, unless otherwise indicated.

### DETAILED DESCRIPTION

The present technology will be described with respect to a four-wheel off-road vehicle 10 having two side-by-side seats 24, 26 and a steering wheel 28. However, it is contemplated that some aspects of the present technology may apply to other types of vehicles such as, but not limited to, off-road vehicles having a handlebar and a straddle seat (i.e., an all-terrain vehicle (ATV)), off-road vehicles having more or less than four wheels, three-wheel vehicles, and snowmobiles.

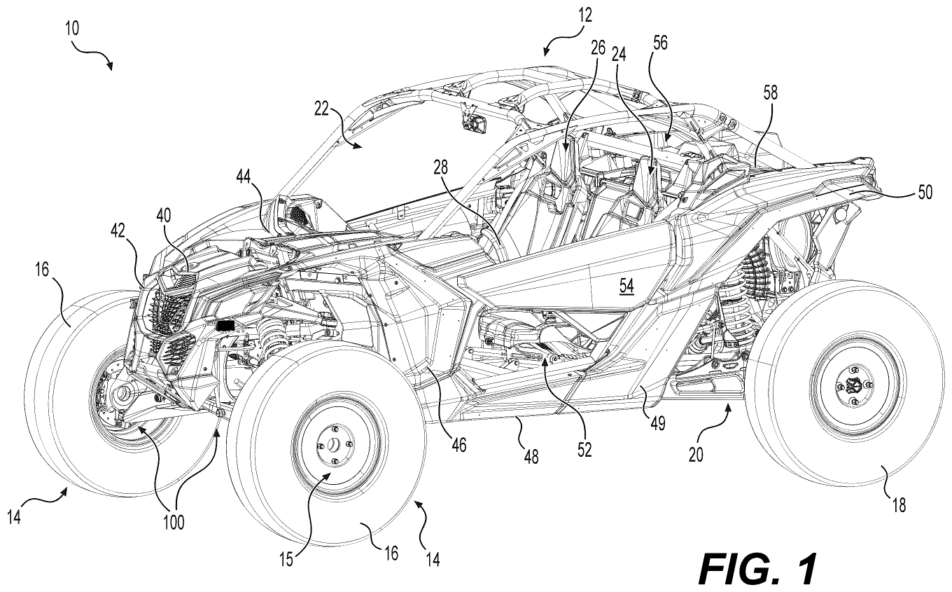

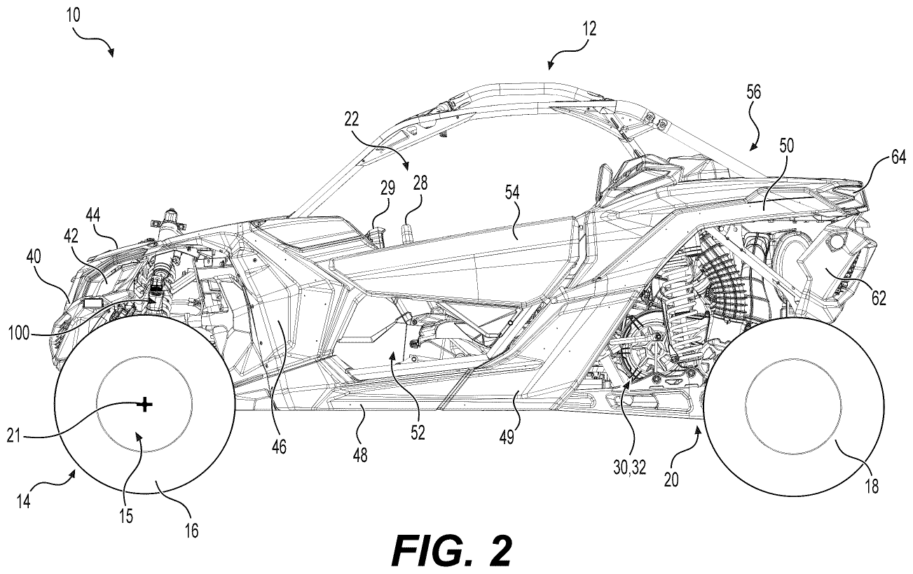

The general features of the off-road vehicle 10 will be described with respect to FIGS. 1 and 2. The vehicle 10 has a frame 12, two front wheels 14 (a front right wheel 14 and a front left wheel 14) connected to a front of the frame 12 by front suspension assemblies 100 (front left suspension assembly 100 and front right suspension assembly 100), and two rear wheels 18 (a rear right wheel 18 and a rear left wheel 18, with only the rear left wheel 18 being shown in the accompanying Figures) connected to the frame 12 by rear suspension assemblies 20. It is contemplated that the number of rear wheels may vary from one vehicle 10 to another.

As further discussed later, in this embodiment, each front suspension assembly 100 is configured to advantageously provide a steering axis extending at a relatively close angle relative to a heightwise direction of the vehicle 10, while defining a clearance zone above its respective wheel 14, thus allowing the wheel 14 to have a relatively large diameter and/or to be replaced by a replacement wheel having a larger diameter.

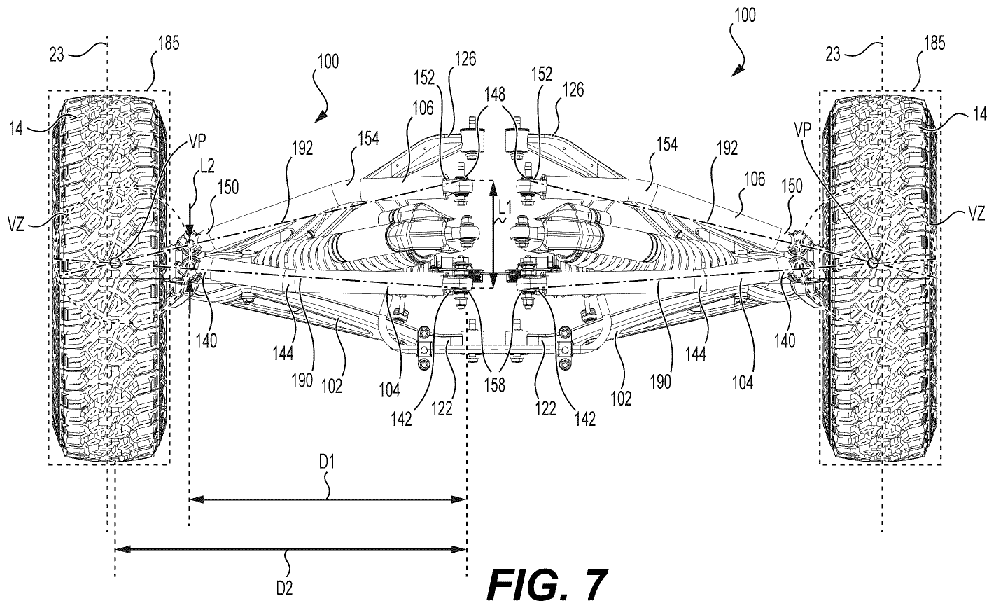

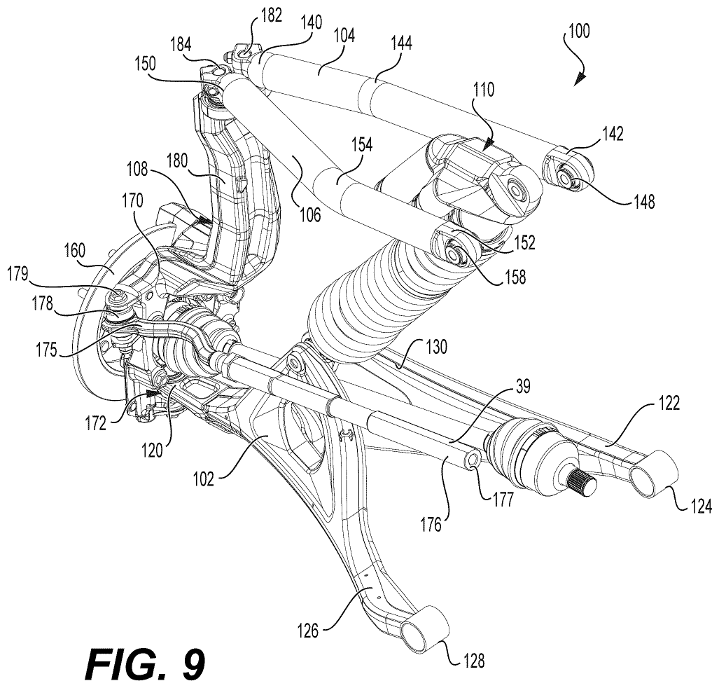

The front wheels 14 each include a rim 15, and a tire 16 mounted to the rim 15. Each of the front wheels 14 is connected to a wheel hub 160 (shown in FIGS. 7 to 9) that is rotationally connected to a knuckle 108 (described below) such that each of the wheels 14 can rotate about a corresponding wheel axis 21. In this embodiment, the tires 16 mounted on the rims 15 are 33-inch diameter tires 16. In other embodiments, rims and/or tires of different sizes may be used. For example, it is contemplated that in other embodiments, the tires 16 may be smaller tires (e.g., 32-inch diameter or less), may be 34-inch diameter tires, 35-inch diameter tires, 36-inch diameter tires, 37-inch diameter tires, 38-inch diameter tires, or may be even larger tires (e.g., 39-inch diameter or more).

The frame 12 defines a central cockpit area 22 inside which are disposed a driver seat 24 and a passenger seat 26. In the present implementation, the driver seat 24 is disposed on the left side of the vehicle 10 and the passenger seat 26 is disposed on the right side of the vehicle 10. However, it is contemplated that the driver seat 24 could be disposed on the right side of the vehicle 10 and that the passenger seat 26 could be disposed on the left side of the vehicle 10.

The central cockpit area comprises a user interface to provide vehicle information and to receive user input from at least the driver. The user interface comprises a steering wheel 28 disposed in front of the driver seat 24. The steering wheel 28 is used to turn the front wheels 14 for steering the vehicle 10 via a steering assembly 31. The user interface may comprises various displays and gauges 29 disposed above the steering wheel 28 to provide information to the driver regarding the operating conditions of the vehicle 10. Examples of displays and gauges 29 include, but are not limited to, a speedometer, a tachometer, a fuel gauge, a transmission position display, and an oil temperature gauge.

As can be seen in FIG. 2, the vehicle 10 includes a motor 30 connected to the frame 12. More particularly, in this embodiment, the motor 30 is located in a rear portion of the vehicle 10. In the illustrated embodiment, the motor 30 is an internal combustion engine, but it is contemplated that the motor 30 could be an electric motor. The engine 30 is operatively connected to a continuously variable transmission (CVT) 32 disposed on a left side of the engine 30. It is contemplated that in some embodiments, the engine 30 could be connected to a dual-clutch transmission instead of a CVT. The CVT 32 is operatively connected to a transaxle (not shown) to transmit power from the engine 30 to the transaxle. The transaxle is operatively connected to the front and rear wheels 14, 18 via a front gear train (not shown) to propel the vehicle 10. The vehicle 10 includes two shafts 39, also referred to as half-shafts 39, which connect the front gear train to the front wheels 14. The left shaft 39 has a laterally outward end connected to the front left wheel 14 and a laterally inward end connected to the front gear train. Likewise, the right shaft 39 has a laterally outward end connected to the front right wheel 14 and a laterally inward end connected to the front gear train.

Still referring to FIGS. 1 and 2, body panels of the vehicle 10 will be described. The body panels are connected to the frame 12. The panels help protect the internal components of the vehicle 10 and provide some of the aesthetic features of the vehicle 10. Front panels 40 are connected to a front of the frame 12. The front panels 40 are disposed forward of the front suspension assemblies 100 and laterally between the front wheels 14. The front panels 40 define two apertures inside which the headlights 42 of the vehicle 10 are disposed. A cover 44 extends generally horizontally reward from a top of the front panels 40. Front fenders 46 are disposed rearward of the front panels 40 on each side of the vehicle 10. Each front fender 46 is disposed in part above and in part behind of its corresponding front wheel 14. Lower panels 48 extend along the bottom of the frame 12 between the front and rear wheels 14, 18. As can be seen in FIG. 2 for the left lower panel 48, each lower panel 48 has a front end disposed under the bottom portion of its corresponding front fender 46 and extends rearward therefrom. A generally L-shaped panel 49 is disposed behind the rear end of each lower panel 48. Generally, L-shaped rear fenders 50 extend upward and then rearward from the rear, upper ends of the L-shaped panels 49. Each rear fender 50 is disposed in part above and in part forward of its corresponding rear wheel 18. The rear fenders 50 define apertures at the rear thereof to receive the brake lights 64 of the vehicle 10. It is contemplated that the brake lights 64 could be replaced with reflectors or that reflectors could be provided in addition to the brake lights 64.

On each side of the vehicle 10, the front fender 46, the lower panel 48, the L-shaped panel 49 and the rear fender 50 define a passage 52 through which a driver (or passenger depending on the side of the vehicle 10) can enter or exit the vehicle 10. Each side of the vehicle 10 is provided with a door 54 that selectively closes an upper portion of the corresponding passage 52. Each door 54 is hinged at a rear thereof to its corresponding rear fender 50 and associated portion of the frame 12 and is selectively connected at a front thereof to its corresponding front fender 46 via a releasable latch (not shown). It is contemplated that each door 54 could be hinged at a front thereof and latched at a rear thereof. As best seen in FIG. 2 for the left side of the vehicle 10, when the doors 54 are closed the lower portions of the passages 52 are still opened. It is contemplated that nets could extend in the lower portions of the passages 52 when the doors 54 are closed or that the doors 54 could be larger so as to close the lower portions of the passages 52. The rear fenders 50 define a cargo space 56 therebetween behind the seats 24, 26.

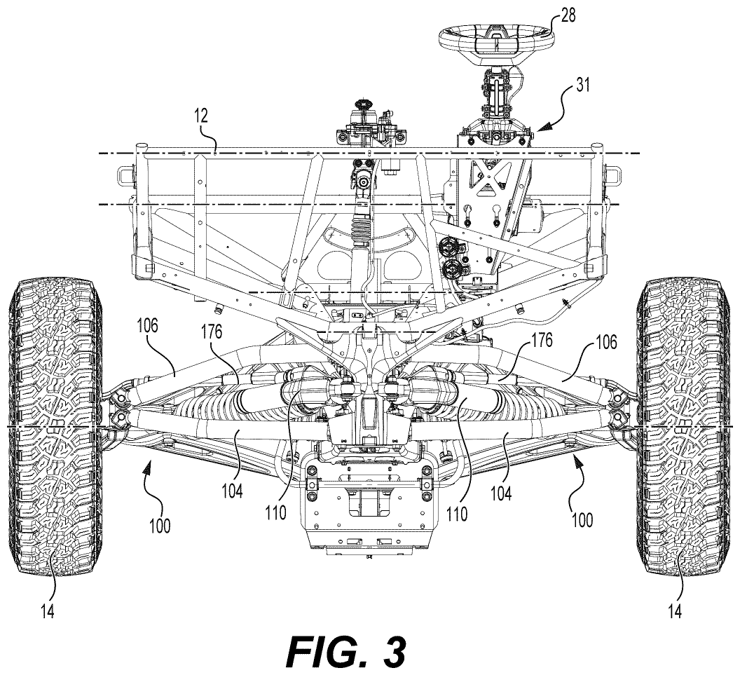

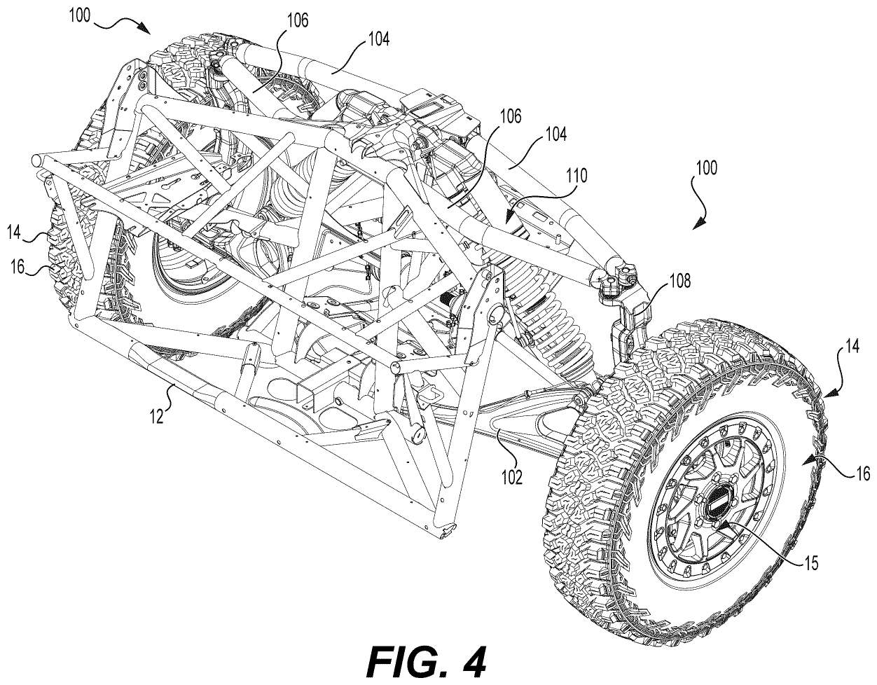

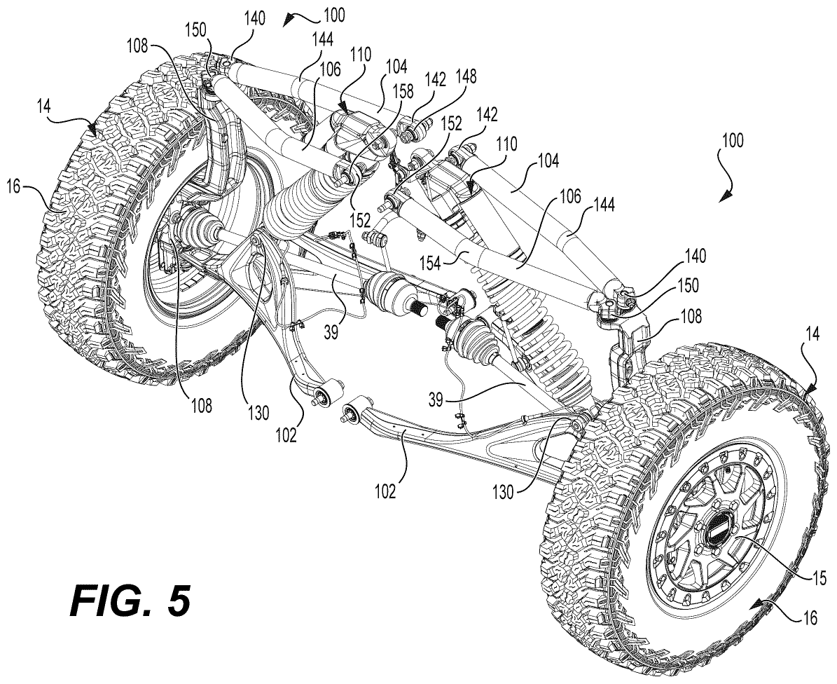

Turning now to FIGS. 3 to 7, the front suspension assemblies 100 will be described in more detail. As the front left and right suspension assemblies 100 are mirror images of each other, only the front left suspension assembly 100 will be described in detail. Components of the front right suspension assembly 100 that correspond to those of the front left suspension assembly 100 have been labeled with the same reference numerals in the Figures.

The front left suspension assembly 100 includes a lower arm 102, an upper front link 104, an upper rear link 106, a knuckle 108 and a shock absorber assembly 110. As will be described below, the lower arm 102 and the upper front and rear links 104, 106 are connected to the frame 12 and to the knuckle 108. The knuckle 108 is moveable relative to the frame 12 thanks to the lower arm 102 and the upper front and rear links 104, 106. Unless indicated otherwise the front left suspension assembly 100 and components related thereto will be described with reference to the front wheels 14 being steered to guide the vehicle 10 straight ahead, and with the vehicle 10 resting on a flat level surface.

In this embodiment, the lower arm 102 is a lower A-arm 102. The lower A-arm 102 has a laterally outward end portion 120 that is pivotally connected to the knuckle 108. The lower A-arm 102 includes a front arm segment 122 on a front side of the lower A-arm 102 and a rear arm segment 126 on a rear side of the lower A-arm 102. The front arm segment 122 includes a laterally inward end portion 124 that is pivotally connected to the frame 12 and the rear arm segment 126 includes a laterally inward end portion 128 that is pivotally connected to the frame 12. The front and rear arm segments 122, 124 are disposed laterally inwardly from the laterally outward end portion 120. The laterally outward end portion 120 is pivotally connected to the knuckle 108 and the laterally inward end portions 124, 128 are pivotally connected to the frame 12.

The lower A-arm 102 also includes a bracket 130 disposed between the laterally outward end portion 120 and the laterally inward end portions 124, 128. By the present implementation, the bracket 130 is integrally formed with the lower A-arm 102. In some cases, the bracket 130 could be welded, fastened, or otherwise connected to the lower A-arm 102.

The bracket 130 connects to a spherical bearing or revolute joint (not shown) of a lower end portion of the shock absorber assembly 110. An upper end portion of the shock absorber assembly 110 is connected to the frame 12 via another bracket and another spherical bearing or revolute joint.

The shock absorber assembly 110 includes two coil springs disposed around a hydraulic shock, although in some implementations the shock absorber assembly 130 could include one coil spring. Since shock absorber assemblies of this type are well known, the shock absorber assembly 130 will not be described in greater detail.

In this embodiment, the shaft 39 for driving the front wheel 14 extends through a space formed between the bracket 130 and the lower A-arm 102. Thus, at least a portion (i.e., a portion, a majority or an entirety) of the shaft 39 may be disposed above the lower A-arm 102 (including a lower surface of the lower A-arm 102) and under a portion of the bracket 130. Furthermore, in this embodiment, the shaft 39 is disposed rearward of a front edge of the lower A-arm 102 and forward of a rear edge of the lower A-arm 102.

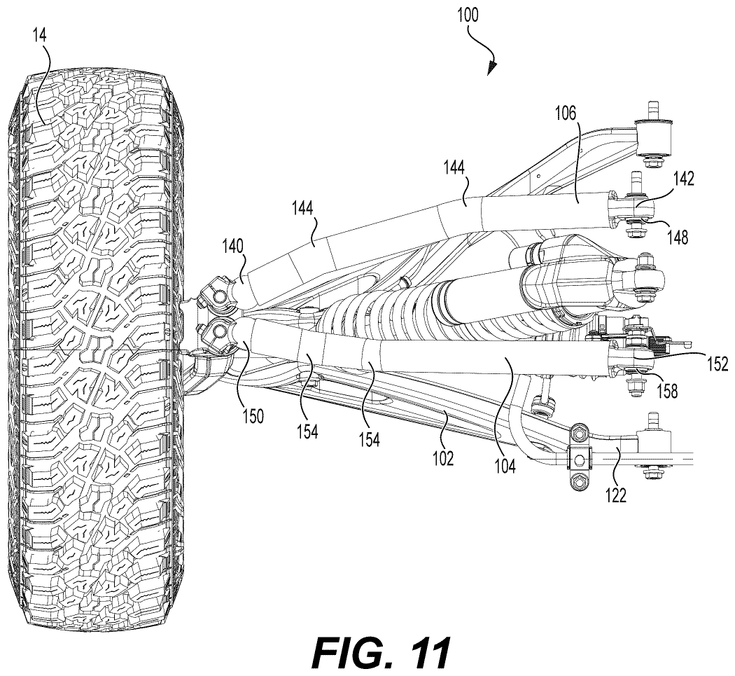

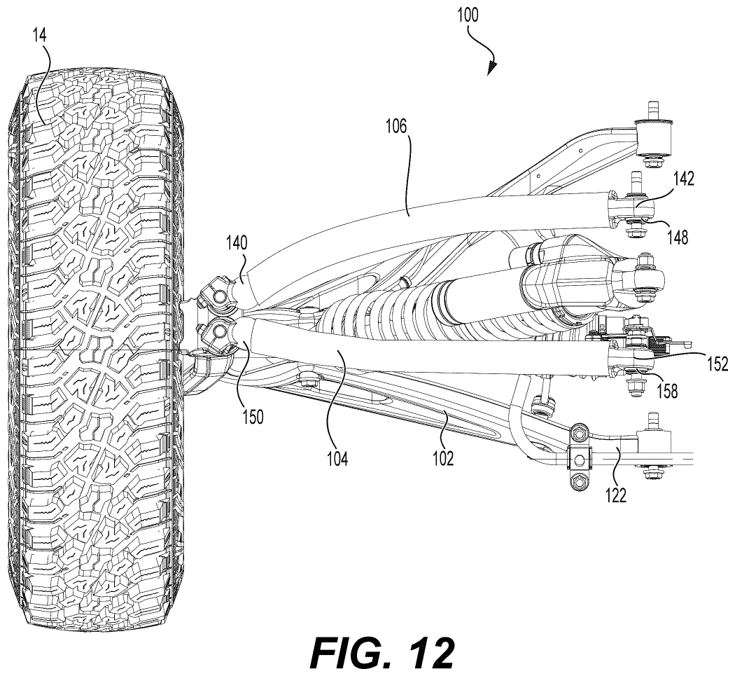

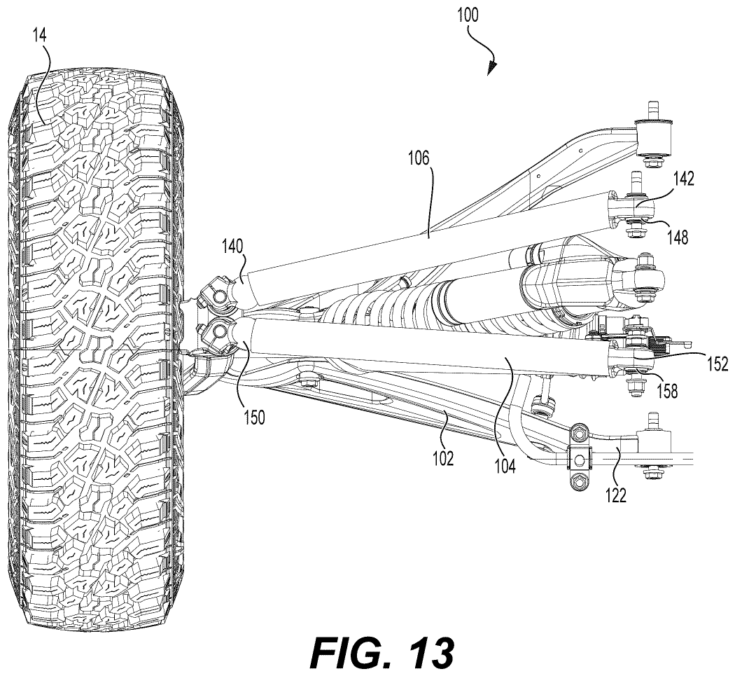

The upper front link 104 has a laterally outward end portion 140 and laterally inward end portion 142. The laterally outward end portion 140, as will be described below, is pivotally connected to the knuckle 108. In the illustrated embodiment, the laterally outward end portion 140 is disposed laterally inwardly from the wheel 14. The laterally inward end portion 142 is pivotally connected to the frame 12 by an inward front ball joint 148. The upper front link 104 has a shoulder 144, which causes the laterally inward and outward end portions 140, 142 to be longitudinally spaced from one another. In the present embodiment, the laterally inward and outward end portions 140, 142 are longitudinally spaced from one another by a distance of between 1 and 3 inches, more specifically about 1.5 inches. In some embodiments, the upper front link 104 may have two or more shoulders 144 (FIG. 11). In other embodiments, the upper front link 104 may be curved (FIG. 12). In yet other embodiments, the upper front link 104 may be straight (FIG. 13).

The upper rear link 106 has a laterally outward end portion 150 and a laterally inward end portion 152. The laterally outward end portion 150, as will be described below, is pivotally connected to the knuckle 108. In the illustrated embodiment, the laterally outward end portion 150 is disposed laterally inwardly from the wheel 14. The laterally inward end portion 152 is pivotally connected to the frame 12 by an inward rear ball joint 158. The upper rear link 106 has a shoulder 154, which results in the laterally inward and outward end portions 150, 152 being longitudinally spaced from one another. In the present embodiment, the laterally inward and outward end portions 150, 152 are longitudinally spaced from one another by a distance of between 3 and 6 inches, more specifically about 5 inches. In some embodiments, the upper rear link 106 may have two or more shoulders 154 (FIG. 11). In other embodiments, the upper rear link 106 may be curved (FIG. 12). In yet other embodiments, the upper rear link 106 may be straight (FIG. 13).

As best seen in FIG. 7, the laterally inward end portion 142 of the upper front link 104 is longitudinally spaced from the laterally inward end portion 152 of the upper front link 106. In the illustrated embodiment, the laterally inward end portions 142, 152 are longitudinally spaced by a distance L1 of at least 6 inches, which advantageously allows clearance between an upper portion of the shock absorber assembly 110 and the upper links 104, 106. It is contemplated that in other embodiments, the laterally inward end portions 142, 152 could be longitudinally spaced by a distance of less than 6 inches (e.g., about 3 inches, about 4 inches, about 5 inches), more than 6 inches (e.g., at least 7 inches, at least 8 inches) or even more (e.g., at least 9 inches).

The laterally outward end portions 140, 150 are also longitudinally spaced from one another. However, the laterally outward end portions 140, 150 are longitudinally closer to one another than the laterally inward end portions 142, 152. As will be described below, the spacing between the laterally outward end portions 140, 150 depends on their connection to the knuckle 108.

One may note that the shoulder 154 is laterally offset from the shoulder 144. This lateral offset between the shoulders 144, 154 can assist increasing clearance between the upper front and rear links 104, 106, especially when the upper front and rear links 104, 106 move relative to one another. More specifically, the upper front and rear links 104, 106 are spaced so as to provide sufficient clearance to receive the shock absorber assembly 110 therebetween. The clearance is sized such that when the front left suspension assembly 100 is in movement (i.e., when the upper front and rear links 104, 106 move relative to the frame 12), the upper front and rear links 104, 106 do not abut the shock absorber assembly 110.

As will also be described below, the respective orientations of the upper front and rear links 104, 106 (convergence of the upper front and rear links 104, 106) provide the front left suspension system 100 with a virtual pivot point VP.

The laterally inward end portions 142, 152 of the upper front and rear links 102, 104 and the laterally inward end portion 128 of the lower A-arm 120 are arranged to connect to vertically separated portions of the frame 12. As such, stresses applied to the frame 12 by operation of the front left suspension assembly 100 are applied to spaced apart portions of the frame 12.

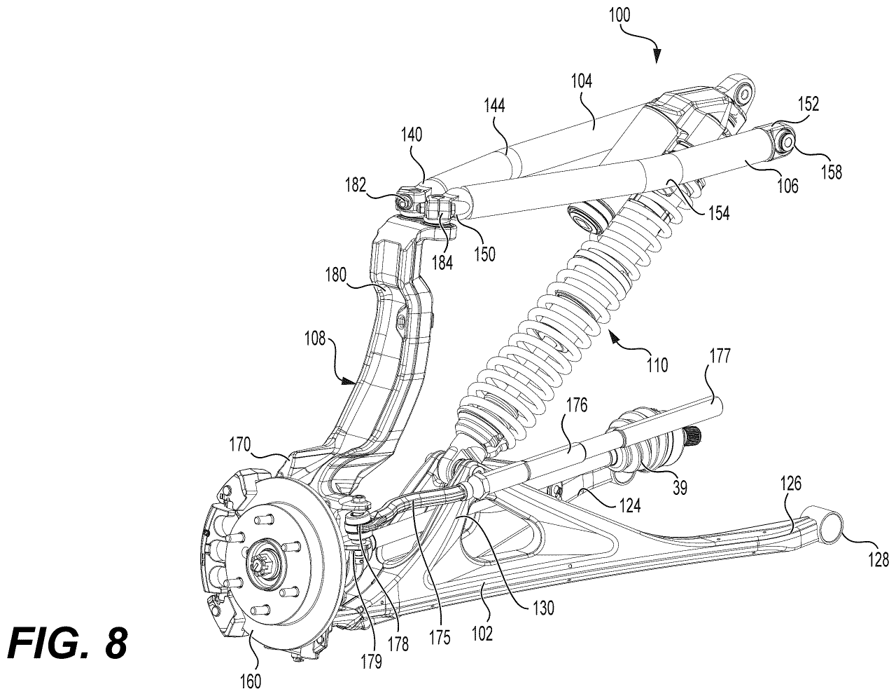

Referring to FIGS. 8 to 10, the knuckle 108 will now be described in greater detail. The knuckle 108 is for connecting the lower arm 102, the upper front link 104 and the upper rear link 106 to the wheel hub 160 and the front wheel 14.

The knuckle 108 includes a lower portion 170 connected to the wheel hub 160. A ball joint 172 is connected to the lower portion 170 and is disposed below the wheel axis 21. The ball joint 172 connects to the laterally outward end portion 120 of the lower A-arm 102. A steering rod 176 is also connected to the lower portion 170. More specifically, the steering rod 176 has a laterally outward end portion 175 that is connected by a steering ball joint 178 to a tab 179 of the knuckle 108. The tab 179 extends from a rear side of the knuckle 108 such that the steering rod 176 is disposed rearward of the shock absorber assembly 110. A laterally inward end portion 177 of the steering rod 176 is operatively connected to the steering wheel 28, such that in response to turning the steering wheel 28, the steering rod 176 moves left or right, which rotates the knuckle 108, and therefore the front wheels 14, about a steering axis 195 (described in greater detail below), thereby steering the vehicle 10 in the direction corresponding to the direction of rotation of the steering wheel 28.

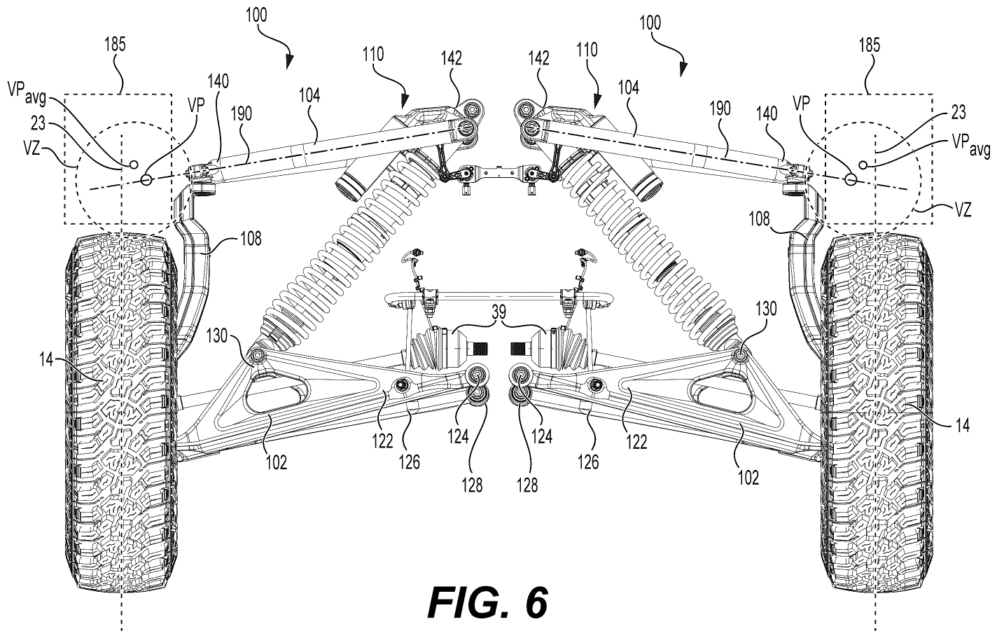

The knuckle 108 further includes an upper portion 180 connected to and extending generally upward from the lower portion 170. Specifically, a first part of the upper portion 180 extends upward (in the heightwise direction of the vehicle 10) and laterally inward from the lower portion 170, and a second part of the upper portion 180 extends upward from the first part. In the present embodiment, the upper and lower portions 170, 180 are integrally formed, but it is contemplated that the upper and lower portions 170, 180 could be separately formed and subsequently welded or fastened together (as one example). As best seen in FIG. 6, a top of the upper portion 180 is disposed, in a heightwise direction of the vehicle 10, higher than a top of the wheel 14. It is contemplated that in some embodiments, such as when a wheel 14 with an increased diameter is used, the top of the upper portion 180 could be aligned with or disposed, in the heightwise direction of the vehicle 10, lower than the top of the wheel 14. When installed on the vehicle 10, the upper portion 180 of the knuckle 108 extends vertically along but spaced from a laterally inward side of the front wheel 14.

An upper front ball joint 182 and an upper rear ball joint 184 are connected to the upper portion 180 and are disposed on a top portion of the knuckle 108. In the present embodiment, the upper front and rear ball joints 182, 184 are spaced from one another in the longitudinal direction of the vehicle 10. In this embodiment, the upper joints 182, 184 are located closely to one another in the heightwise direction of the vehicle 10. For instance, in some embodiments, a distance between the upper joints 182, 184 is less than 1 inch, in some embodiments less than 0.5 inch, in some embodiments less than 0.2 inch, and in some embodiments even less. The laterally outward end portion 140 of the upper front link 104 is pivotally connected to the top of the knuckle 108, specifically to the upper front ball joint 182. The laterally outward end portion 150 of the upper rear link 106 is pivotally connected to the top of the knuckle 108, specifically to the upper rear ball joint 184.

In this embodiment, the front suspension assembly 100 and the wheel 14 define a virtual clearance zone 185 above the wheel 14. In the illustrated embodiment (i.e., the wheel 14 being laterally offset from the frame 12), the virtual clearance zone 185 is defined, in the heightwise direction, between the top of the wheel 14 and a given distance from the top of the wheel 14. It will be appreciated that the virtual clearance zone 185 is free from any components of the vehicle 10. That is, the front left suspension assembly 100 is completely outside of the virtual clearance zone 185. More specifically, the upper front and rear links 104, 106 and the knuckle 108 are all sized and oriented to be completely outside of the virtual clearance zone 185. In some embodiments, there may be one or more components of the vehicle 10 disposed above the virtual clearance zone 185. It is contemplated that in some embodiments where the wheel 14 is disposed below part of the frame 12, the virtual clearance zone 185 may generally be defined, in the heightwise direction, between the top of the wheel 14 and a bottom of the frame 12 of the vehicle 10, and in the lateral direction, between the laterally inward and outward sides of the wheel 14. In other embodiments, removable parts of the vehicle 10 and/or accessories may be temporarily attached to the vehicle 10 and may be at least partly above the wheel 14, but may be removable from the vehicle 10 if necessary (e.g., to allow replacing the wheel 14 by a larger wheel).

With reference to FIGS. 6, 7 and 10, the virtual pivot point VP will now be described in greater detail. The virtual pivot point VP is determined by the upper front and rear links 104, 106. In more detail, in the illustrated embodiment, the virtual pivot point VP is located at an intersection of a front arm line 190 and a rear arm line 192. The front arm line 190 is a virtual line that extends through a center of the inward front ball joint 148 (i.e., through the laterally inward end portion 142 of the upper front link 104) and a center of the upper front ball joint 182 (i.e., through the laterally outward end portion 140). The rear arm line 192 is a virtual line that extends through a center of the inward rear ball joint 158 (i.e., through the laterally inward end portion 152 of the upper rear link 106) and a center of the upper rear ball joint 184 (i.e., through the laterally outward end portion 150). Due to the configuration of the upper front and rear links 104, 106 (i.e., convergence due to the shoulders 144, 154), the front and rear arm lines 190, 192 intersect, and define the virtual pivot point VP. It is contemplated that in other embodiments where the shoulders 144, 154 are omitted, the upper front and rear links 104, 106 would be oriented such that their corresponding front and rear arm lines 190, 192 would intersect proximate to the wheel 14.

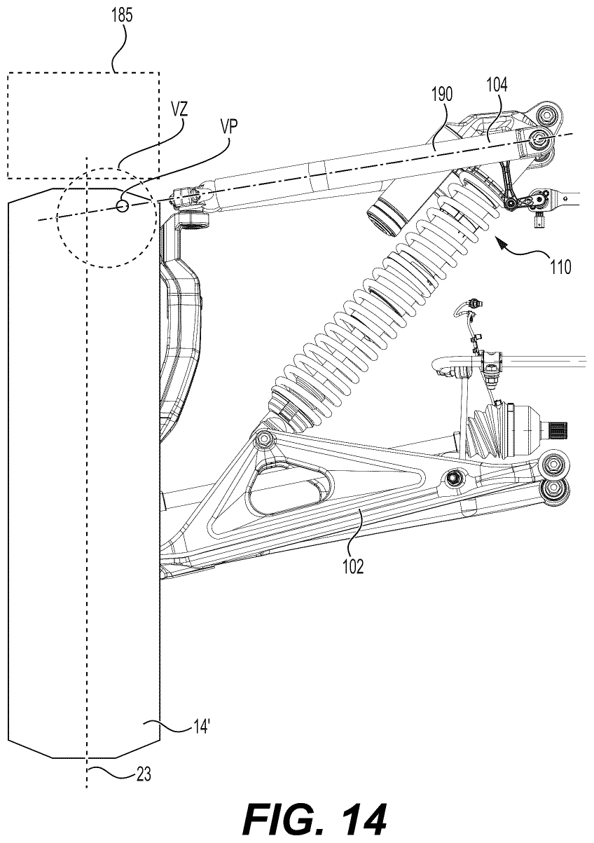

In the present embodiment, the virtual pivot point VP is disposed, in a lateral direction, between inward and outward lateral surfaces of the wheel 14. More specifically, the virtual pivot point VP is disposed laterally inwardly from a radial center plane 23 of the wheel 14. In a heightwise direction of the vehicle 10, the virtual pivot point VP is disposed higher than the wheel rotation axis 21, and higher than the top of the wheel 14. Thus, the virtual pivot point VP is disposed in the virtual clearance zone 185. It is contemplated that in some embodiments, the virtual pivot point VP may be disposed laterally inward from the inward lateral side of the wheel 14. In other embodiments, the virtual pivot point VP may be disposed laterally outwardly from the radial center plane 23 of the wheel 14. It is also contemplated that the virtual pivot point VP may be disposed laterally outward from the outward lateral side of the wheel 14. It is contemplated that in other embodiments, the virtual pivot point VP could be aligned with the top of the wheel 14 or disposed lower than the top of the wheel 14. For example, in FIG. 14, the wheel 14 has been replaced by a replacement wheel 14′ having a larger diameter than the wheel 14, and the virtual pivot point VP at rest may be located below a top of the wheel 14′. It is contemplated that in some embodiments, the virtual pivot point VP may be generally aligned with the top of the wheel 14.

During operation of the vehicle 10, the front left wheel 14 may move, which moves the front left suspension assembly 100. More specifically, in response to the wheel 14 moving, the knuckle 108, the lower A-arm 102 and the upper front and rear links 104, 106 may all move relative to one another and relative to the frame 12 of the vehicle 10. Movement of the upper front and rear links 104, 106 results in the virtual pivot point VP also moving. In some instances, the wheel 14 and the knuckle 108 may be caused to move by the steering rod 176. Movement of the knuckle 108 moves the upper front and rear links 104, 106, which results in movement of the virtual pivot point VP. It can be said that in response to the movement of the upper front and rear links 104, 106 (i.e., in response to a movement of the wheel 14), for every position of the front left suspension assembly 100, the virtual pivot point VP has a corresponding position. An average of the corresponding positions provides an average virtual pivot point VPavg. In this embodiment, the average virtual pivot point VPavg is disposed laterally between inward and outward lateral side surfaces of the wheel 14 and is offset from (higher than) the virtual pivot point VP when the front left suspension assembly 100 is at rest (shown in FIG. 6). In this embodiment, at rest, the shock absorber assembly 110 may be at a position closer to its fully extended position than to its fully compressed position, and as such, the average virtual pivot point VPavg may be positioned higher in the heightwise direction of the vehicle 10 than the virtual pivot point VP relative to the wheel 14. In other embodiments, at rest, the shock absorber assembly 110 may be at a position closer to its fully compressed position than to its fully extended position, and as such, the average virtual pivot point VPavg may be positioned lower in the heightwise direction of the vehicle 10 than the virtual pivot point VP relative to the wheel 14.

All the possible positions of the virtual pivot point VP define a virtual zone VZ. Thus, as the wheel 14 moves across its full range of motion, the virtual pivot point VP moves across the whole virtual zone VZ. The virtual zone VZ is illustrated in the accompanying Figures as a sphere for simplicity, but the virtual zone VZ may have a more complex shape. In some instances, the virtual zone VZ may have a bean-like shape. In this embodiment, at least a majority (i.e., a majority or an entirety) of the virtual zone VZ is disposed between the inward and outward lateral sides of the wheel 14. Additionally, at least a majority of the virtual zone VZ is disposed above the wheel rotation axis 21. The virtual zone VZ may at least partially overlap with the virtual clearance zone 185.

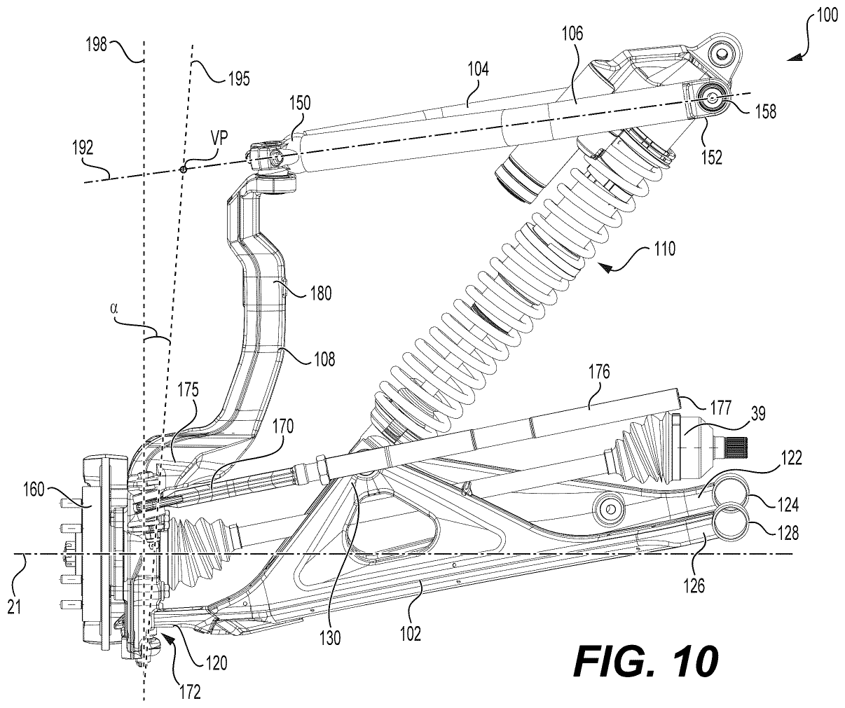

The knuckle 108 pivots relative to the lower A-arm 102 and the upper front and rear links 104, 106 about the steering axis 195 (FIG. 10), which can also be referred to as a kingpin axis. In the present embodiment, the steering axis 195 is defined by a line 195 extending through the lower ball joint 172 and the virtual pivot point VP. It will be noted that since the virtual pivot point VP is moveable, the orientation of the steering axis 195 may change.

With the vehicle 10 being at rest on a flat level surface, and the front wheels 14 being steered to guide the vehicle 10 straight ahead, the steering axis 195 is oriented at an angle α of between 0° degree and 6°, in some embodiments of between 2° degree and 4°, and in some embodiments of about 3° with respect to a vertical plane 198 that extends generally parallel to the heightwise direction of the vehicle 10. More specifically, in this embodiment, the angle α may be greater than 0°. This configuration may reduce a movement of the vehicle 10 in the heightwise direction of the vehicle 10 during steering of the vehicle 10, thus reducing strain on mechanical parts of the steering and the suspension assembly 100, and improving a manoeuvrability of the vehicle 10, while maintaining a directional stability of the steering system, notably when the vehicle travels through obstacles.

The orientation and position of the steering axis 195 with respect to the radial center plane 23 provides a small scrub radius (not shown), which can assist in reducing steering efforts, reducing mechanical stresses resulting from steering, while also improving steering responsiveness. These improvements are partially enabled by the virtual pivot point VP being disposed generally above the wheel 14.

While the use of the two upper front and rear links 104, 106 with laterally inward ends 140, 150 being laterally spaced from the wheel 14 (i.e., use of shorter arms) provides the virtual pivot point VP and provides clearance from the virtual clearance zone 185, the two upper front and rear links 104, 106 are also sufficiently long to limit camber variation during use of the vehicle 10. With reference to FIG. 7, a lateral distance D1 extends from the radially inward portion 142 to the radially outward portion 140, and a lateral distance D2 extends from the radially inward portion 142 to the virtual pivot point VP. A ratio of the lateral distance D1 over the lateral distance D2 may be relatively long, which may result in reducing camber variation during use of the vehicle 10. For example, in some embodiments, the ratio of the lateral distance D1 over the lateral distance D2 may be at least 0.70 (e.g., between 0.70 and 0.85), in some embodiments at least 0.75 (e.g., between 0.75 and 0.80), and in some embodiments at least 0.77 (e.g., about 0.77).

In the illustrated embodiment, the lateral distances D1 and D2 are generally similar for the upper front and rear links 104, 106. It is contemplated however, that in some embodiments, the lateral distances D1 and D2 may vary from the upper front link 104 to the upper front link 106.

Thus, the upper front and rear links 104, 106 are long enough to limit camber variation, are short enough to not extend into the virtual clearance zone 185 and thus not limit wheel size, and are also short enough to accommodate the upper ball joints 182, 184 while also defining the virtual pivot point VP above the wheel 14, thus providing the steering axis 195 that has a small angle relative to the vertical plane 198, as discussed above. For instance, to accommodate the upper ball joints 182, 184 while also defining the virtual pivot point VP above the wheel 14, the laterally outward ends 140, 150 of the upper front and rear links 104, 106 may be spaced from one another in the longitudinal direction of the vehicle by between 0.5 inch and 4 inches, in some embodiments by a distance L2 between 1 inch and 3 inches, and in some embodiments by about 2 inches, and a center-to-center spacing of the upper ball joints 182, 184 may be between 0.5 inch and 4 inches, in some embodiments by between 1 inch and 3 inches, and in some embodiments by about 2 inches.

Additionally, in this embodiment, the virtual pivot point VP is defined by only four ball joints (one ball joint (inward front ball joint 148, inward rear ball joint 158, upper front ball joint 182 and upper rear ball joint 184) at each of the laterally outward ends 140, 150 and laterally inward ends 142, 152). This can assist in minimizing complexity and cost of the front left suspension assembly 100.

As best seen in FIG. 6, the arrangement of the knuckles 108, the lower A-arms 102, the upper front and rear links 104, 106, and the shock absorber assemblies 110 provide front suspension assemblies 100 that are connected to the frame 12 relatively close to a center of the vehicle 10 in order to provide a relatively large range of motion for the front wheels 14 relative to the vehicle frame 12.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A vehicle comprising:
a frame;
a front left suspension assembly connected to the frame;
a front left wheel operatively connected to the front left suspension assembly;
a front right suspension assembly connected to the frame;
a front right wheel operatively connected to the front right suspension assembly;
at least one rear wheel operatively connected to the frame;
a motor operatively connected to at least one of:
the front left wheel and the front right wheel; and
the at least one rear wheel;
each of the front left suspension assembly and the front right suspension assembly comprising:
a knuckle pivotally connected to a corresponding one of the front left wheel and the front right wheel, the knuckle including:
a wheel hub operatively connected to the corresponding one of the front left wheel and the front right wheel;
a first portion connected to the wheel hub, the first portion including a lower ball joint, and
a second portion connected to and extending generally upward from the first portion, the second portion including a first upper ball joint and a second upper ball joint,
with the front left wheel and the front right wheel being steered to guide the vehicle straight ahead, the first upper ball joint and the second upper ball joint are longitudinally spaced from one another;
a lower arm having a laterally outward end portion pivotally connected to the lower ball joint of the knuckle and two laterally inward end portions pivotally connected to the frame;
a first upper link having a laterally outward end portion pivotally connected to the first upper ball joint, and a laterally inward end portion pivotally connected to the frame,
a second upper link having a laterally outward end portion pivotally connected to the second upper ball joint, and a laterally inward end portion pivotally connected to the frame, the laterally inward end portion of the second upper link being longitudinally spaced from the laterally inward end portion of the first upper link,
a shock absorber assembly having a lower end portion pivotally connected to the lower arm and an upper end portion pivotally connected to the frame.

2. The vehicle of claim 1, wherein for each of the front left suspension and the front right suspension assembly:
the laterally outward end portion of the first upper link is disposed laterally between the laterally inward end portion of the first upper link and the corresponding one of the front left wheel and the front right wheel; and
the laterally outward end portion of the second upper link is disposed laterally between the laterally inward end portion of the second upper link and the corresponding one of the front left wheel and the front right wheel.

3. The vehicle of claim 1, wherein, for each of the front left suspension and the front right suspension assembly:
a virtual pivot point is determined at an intersection of:
a first line extending through the laterally inward end portion of the first upper link and through the first upper ball joint; and
a second line extending through the laterally inward end portion of the second upper link and through the second upper ball joint, and
the corresponding one of the front left wheel and the front right wheel is steerable about a steering axis defined by the virtual pivot point and the lower ball joint.

4. The vehicle of claim 3, wherein for each of the front left suspension assembly and the front right suspension assembly, with the front left wheel and the front right wheel being steered to guide the vehicle straight ahead, the virtual pivot point is disposed laterally between an inward side of the corresponding one of the front left wheel and the front right wheel and an outward side of the corresponding one of the front left wheel and the front right wheel.

5. The vehicle of claim 3, wherein for each of the front left suspension assembly and the front right suspension assembly, the virtual pivot point is located higher than, in a heigthwise direction of the vehicle, a top of the corresponding one of the front left wheel and the front right wheel.

6. The vehicle of claim 3, wherein for each of the front left suspension assembly and the front right suspension assembly, the virtual pivot point is located lower than, in a heigthwise direction of the vehicle, a top of the corresponding one of the front left wheel and the front right wheel.

7. The vehicle of claim 3, wherein for each of the front left suspension assembly and the front right suspension assembly,
in response to a movement of the corresponding one of the front left wheel and the front right wheel, the virtual pivot point is moveable in a virtual zone; and
the virtual zone is located higher than, in a heigthwise direction of the vehicle, a wheel rotation axis of the corresponding one of the front left wheel and the front right wheel.

8. The vehicle of claim 7, wherein for each of the front left suspension assembly and the front right suspension assembly, at least a majority of the virtual zone is disposed between an inward side of the corresponding one of the front left wheel and the front right wheel, and an outward side of the corresponding one of the front left wheel and the front right wheel.

9. The vehicle of claim 3, wherein for each of the front left suspension assembly and the front right suspension assembly, with the front left wheel and the front right wheel being steered to guide the vehicle straight ahead and with the vehicle resting on a flat level surface, an angle between the steering axis and a heightwise direction of the vehicle is greater than 0 degrees and less than or equal to 6 degrees.

10. The vehicle of claim 9, wherein for each of the front left suspension assembly and the front right suspension assembly, with the front left wheel and the front right wheel being steered to guide the vehicle straight ahead and with the vehicle resting on a flat level surface, the angle between the steering axis and the heightwise direction of the vehicle is greater than 2 degrees and less than or equal to 4 degrees.

11. The vehicle of claim 3, wherein for each of the front left suspension assembly and the front right suspension assembly, with the front left wheel and the front right wheel being steered to guide the vehicle straight ahead and with the vehicle resting on a flat level surface:
a first lateral distance is defined from the laterally inward end portion of the first upper link to the laterally outward end portion of the first upper link;
a second lateral distance is defined from the laterally inward end portion of the first upper link to the virtual pivot point;
a ratio of the first lateral distance over the second lateral distance is between 0.7 and 0.85; and
a third lateral distance is defined from the laterally inward end portion of the second upper link to the laterally outward end portion of the second upper link;
a fourth lateral distance is defined from the laterally inward end portion of the second upper link to the virtual pivot point;
a ratio of the third lateral distance over the fourth lateral distance is between 0.7 and 0.85.

12. The vehicle of claim 11, wherein for each of the front left suspension assembly and the front right suspension assembly:
the ratio of the first lateral distance over the second lateral distance is between 0.75 and 0.8; and
the ratio of the third lateral distance over the fourth lateral distance is between 0.75 and 0.8.

13. The vehicle of claim 1, wherein for each of the front left suspension assembly and the front right suspension assembly, a center-to-center spacing between the first upper ball joint and the second upper ball joint is between 0.5 inches and 4 inches.

14. The vehicle of claim 1, wherein for each of the front left suspension assembly and the front right suspension assembly, a corresponding one of the front left suspension assembly and the front right suspension assembly is completely outside of a zone defined above the corresponding one of the front left wheel and the front right wheel in a heightwise direction of the vehicle.

15. The vehicle of claim 1, wherein the front suspension is configured to accommodate a tire having an outer diameter of at least 33 inches.

16. The vehicle of claim 1, wherein for each of the front left suspension assembly and the front right suspension assembly, the shock absorber assembly is disposed longitudinally between the first upper link and the second upper link.

17. The vehicle of claim 1, further comprising:
a driver seat connected to the frame;
a steering wheel disposed forward of the driver seat;
a steering assembly operatively connected to the steering wheel; and
wherein each of the front left suspension assembly and the front right suspension assembly further comprises:
a steering ball joint connected to the knuckle, and
a steering rod having a laterally inward end portion operatively connected to the steering assembly, and a laterally outward end portion connected to the steering ball joint.

18. The vehicle of claim 17, wherein for each of the front left suspension assembly and the front right suspension assembly, the steering rod is disposed rearward of the shock absorber assembly.

19. The vehicle of claim 1, further comprising:
a rear left suspension assembly connected to the frame;
a rear right suspension assembly connected to the frame; and
wherein
the at least one rear wheel includes:
a rear left wheel operatively connected to the rear left suspension assembly; and
a rear right wheel operatively connected to the rear right suspension assembly.

20. A vehicle comprising:
a frame;
a front left suspension assembly connected to the frame;
a front left wheel operatively connected to the front left suspension assembly;
a front right suspension assembly connected to the frame;
a front right wheel operatively connected to the front right suspension assembly;
at least one rear wheel operatively connected to the frame;
a motor operatively connected to at least one of:
the front left wheel and the front right wheel; and
the at least one rear wheel;
each one of the front left suspension and the front right suspension comprising:
a knuckle operatively connected to a corresponding one of the front left wheel and the front right wheel;
at least one lower arm connected between the knuckle and the frame;
at least one upper arm connected between the knuckle and the frame;
wherein, for each one of the front left suspension and the front right suspension:
with the front left wheel and the front right wheel being steered to guide the vehicle straight ahead, a corresponding one of the front left wheel and the front right wheel is steerable about a steering axis defined by a virtual pivot point and a connection between the knuckle and the at least one lower arm, the virtual pivot point being located laterally between an inner side of the corresponding one of the front left wheel and the front right wheel and an outer side of the corresponding one of the front left wheel and the front right wheel; and
a corresponding one of the front left suspension assembly and the front right suspension assembly being completely outside of a zone defined above the corresponding one of the front left wheel and the front right wheel in a heightwise direction of the vehicle.
